(19) United States
(12) Patent Application Publication
(10) Pub. No.: US 2023/0344141 A1
(43) Pub. Date: Oct. 26, 2023

(54) ANTENNA DEVICE AND DETECTION SYSTEM

(71) Applicant: CANON KABUSHIKI KAISHA, Tokyo (JP)

(72) Inventors: TATSUHITO GODEN, Tokyo (JP); TAKAHIRO SATO, Kanagawa (JP); TAKEAKI ITSUJI, Kanagawa (JP)

(21) Appl. No.: 18/301,872

(22) Filed: Apr. 17, 2023

(30) Foreign Application Priority Data
Apr. 22, 2022 (JP) 2022-071139

(51) Int. Cl. H01Q 21/00; H01Q 21/06

(52) U.S. Cl. CPC H01Q 21/0006; H01Q 21/061

(57) ABSTRACT

An antenna device includes an antenna array constituted by a plurality of antennas disposed on a support substrate, a signal-processing substrate configured to be stacked with the support substrate, a plurality of rectifier elements disposed correspondingly to each of the plurality of antennas, and a peripheral electrode disposed between the plurality of antennas on the support substrate The antenna includes a first part electrically connected to one of terminals of the rectifier element, a second part electrically connected to the other terminal of the rectifier element, a first lead line connected to the first part, a second lead line connected to the second part, and a first through electrode connected to the first lead line and the signal-processing substrate, and the second lead line of the antenna is connected to the peripheral electrode.

### BACKGROUND OF THE INVENTION

### Field of the Invention

This disclosure relates to an antenna device which receives an electromagnetic wave and a detection system.

### Description of the Related Art

A terahertz wave can be defined as an electromagnetic wave having a frequency of at least 30 GHz and not more than 30 THz. Such a detection system that conducts an inspection by irradiating an object with this terahertz wave so as to acquire an image by a detection device which receives a reflected terahertz wave is known.

A heat-sensing type sensor such as a bolometer is used as the detecting device in some cases, but it is susceptible to a low-frequency noise such as a 1/f noise and moreover, since speed-up of a framerate in a moving-image pickup is difficult, lowering of a noise could not be realized easily.

Thus, a detecting device that realizes higher speed and lower noise by an antenna device including an antenna array with antennas receiving terahertz waves disposed two-dimensionally as pixels and combining signal processing circuits which process signals from the antennas has been proposed.

As the antenna array, U.S. Publication No. 2018/0212307 discloses a configuration in which each of the antennas is disposed by being surrounded by a common electrode. The common electrode is connected to a conductive layer on a lower layer by via so as to lower impedance and reduces potential fluctuation of the common electrode and suppresses a crosstalk between the antennas.

In an image pickup device in which an antenna substrate on which an antenna array is mounted and a signal processing circuit which processes a signal from the antenna are laminated, it is necessary to connect to the signal processing circuit through a through electrode for each antenna in each pixel. In the image pickup device as above, if an arrangement pitch of the antennas is narrowed by increasing a resolution of an image to be acquired, alignment accuracy required for positioning of the antenna substrate and a circuit board rises. In this case, in the antenna array disclosed in U.S. Publication No. 2018/0212307 in which a large number of through electrodes are disposed, bonding defects can easily occur in the through electrode, and a possibility of occurrence of pixel defects is high. Thus, reduction in potential fluctuation while pixel defects are suppressed by decreasing the number of through electrodes is in demand.

### SUMMARY OF THE INVENTION

This disclosure was made in view of the above and has an object to provide an antenna device which suppresses crosstalk between antennas while suppressing pixel defects and improves image qualities and yields.

According to some embodiments, an antenna device includes an antenna array constituted by a plurality of antennas disposed on a support substrate, a signal-processing substrate configured to be stacked with the support substrate, a plurality of rectifier elements disposed correspondingly to each of the plurality of antennas, and a peripheral electrode disposed between the plurality of antennas on the support substrate, wherein the antenna includes a first part electrically connected to one of terminals of the rectifier element, a second part electrically connected to the other terminal of the rectifier element, a first lead line connected to the first part, a second lead line connected to the second part, and a first through electrode connected to the first lead line and the signal-processing substrate, and the second lead line of the antenna is connected to the peripheral electrode.

According to some embodiments, a detection system includes the antenna device as described above, a transmitting device for transmitting an electromagnetic wave, and a processing portion which processes a signal from the antenna device.

Further features of the present disclosure will become apparent from the following description of exemplary embodiments with reference to the attached drawings.

### BRIEF DESCRIPTION OF THE DRAWINGS

FIG. 1 is an example of a plan view of a pixel of an antenna device according to a first embodiment.

FIG. 2 is an example of a sectional view of the pixel of the antenna device according to the first embodiment.

FIG. 3 is an example of a sectional view of the pixel of the antenna device according to the first embodiment.

FIG. 4 is an example of a sectional view of the pixel of the antenna device according to the first embodiment.

FIG. 5 is an example of a graph illustrating output characteristics of the antenna device according to the first embodiment.

FIG. 6 is an example of a circuit configuration of the antenna device according to the first embodiment.

FIG. 7 is an example of a plan view of an antenna array of the antenna device according to the first embodiment.

FIG. 8 is an example of a plan view of the antenna array of the antenna device according to the first embodiment.

FIG. 9 is an example of a plan view of a pixel of an antenna device according to a second embodiment.

FIG. 10 is an example of a plan view of the pixel of the antenna device according to the second embodiment.

FIG. 11 is an example of a plan view of a pixel of an antenna device according to a third embodiment.

FIG. 12 is a schematic diagram for explaining a camera system according to a fourth embodiment.

### DESCRIPTION OF THE EMBODIMENTS

Hereinafter, various exemplary embodiments, features, and aspects of this enclosure will be explained in reference to the accompanying drawings. This disclosure is not limited to the following embodiments but can be changed as appropriate within a range not departing from the gist thereof. Moreover, in the drawings explained below, those having the same functions are given the same signs, and the explanation therefor will be omitted or simplified in some cases.

### First Embodiment

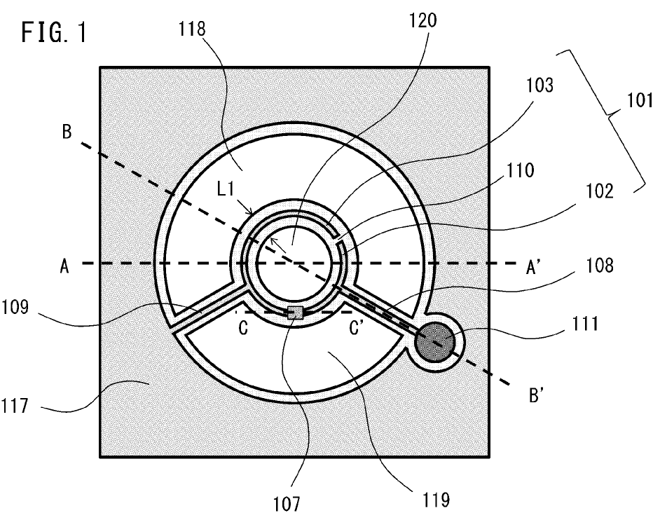

An antenna device in a first embodiment of this disclosure will be explained by using FIGS. 1 to 8.

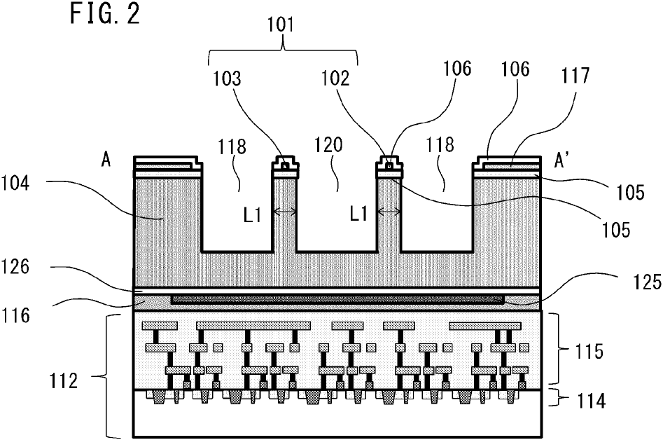

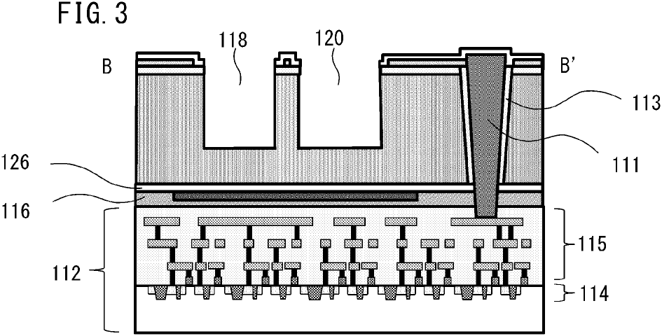

(Pixel Configuration) FIG. 1 is a plan view illustrating a pixel of the antenna device in this embodiment. FIG. 2 is a sectional view on an A-A′ line in FIG. 1. FIG. 3 is a sectional view on a B-B′ line in FIG. 1.

The pixel of the antenna device in this embodiment includes a loop antenna 101 having a ring shape as an example of the antenna of this embodiment and is disposed on an antenna substrate 104, which is a support substrate. For the antenna substrate 104, a semiconductor substrate such as Si, GaAs, InP or the like is used. Here, since the loop antenna 101 is constituted by a thin film of metal or an alloy having conductivity, contact with the antenna substrate 104 is made through an insulating layer 105 so as not to be electrically connected. As a material for the loop antenna 101, metal such as Ag, Au, Cu, W, Ni, Cr, Ti, Al, AlCu, AlSi, AuIn, TiN and alloys are used, for example. The loop antenna 101 receives an electromagnetic wave in a terahertz frequency band. It receives the electromagnetic wave (hereinafter, referred to simply as a “terahertz wave”) including at least a part of the frequency bands from a millimeter-wave band to a terahertz band (at least 30 GHz and not more than 30 THz).

A layer constituting the insulating layer 105 is silicon oxide, BPSG, PSG, BSG, silicon nitride, silicon carbide, for example. Moreover, the loop antenna 101 is covered by an insulating layer 106 for protection, and the insulating layer 106 may use a material similar to that of the insulating layer 105.

A rectifier element 107 is provided on the antenna substrate 104 and is connected to the loop antenna 101. In the loop antenna 101, a slit 110 for driving the rectifier element 107 is provided, and it is divided into a first part 102 and a second part 103 with the rectifier element 107 between them. At the slit 110, a capacity is formed between the first part 102 and the second part 103, and capacitive coupling is made.

A first lead line 108 is electrically connected to the first part 102, and a second lead line 109 is electrically connected to the second part 103. The first lead line 108 and the second lead line 109 extend perpendicularly to a tangent line of a loop part of the loop antenna 101. A driving voltage or current can be applied to both ends of the rectifier element 107 through the first lead line 108 and the second lead line 109. A voltage application condition in this case is that the voltage should be applied so that an electric current flows in a forward direction in the rectifier element 107.

The first lead line 108 and the second lead line 109 in this embodiment are connected to a node position of an electromagnetic field distributed in the loop antenna 101, and even if another circuit or wiring is connected to the first lead line 108 or the second lead line 109, antenna characteristics can be maintained. The node of the electromagnetic field, here, refers to a spot where impedance of the electromagnetic field distributed in the loop antenna 101 can be regarded to be zero with respect to a wavelength λ (resonance wavelength λ) in the loop antenna 101 of an electric wave with a frequency selected as a resonance frequency. The resonance wavelength λ will be explained in the section “Loop Antenna”, which will be described later.

The first lead line 108 is connected to a first through electrode 111. The first through electrode 111 is formed so as to penetrate the antenna substrate 104 and is connected to a signal-processing circuit board 112 as a signal-processing substrate which is stacked with the antenna substrate 104. Between the first through electrode 111 and the antenna substrate 104, an insulating layer 113 is formed so that they are not electrically connected. Between the antenna substrate 104 and the signal-processing circuit board 112, an adhesion layer 116 for joining them is disposed. As the adhesion layer 116, a thermally curable resin is preferable, and benzocyclobutene (BCB: Benzocyclobutene) can be used, for example.

The first through electrode 111 is made by the following procedure. First, the antenna substrate 104 and the signal-processing circuit board 112 are bonded by the adhesion layer 116. At a spot where the first through electrode 111 is to be provided by a method such as dry etching, a contact-hole machining is performed in the antenna substrate 104 until a wiring of the signal-processing circuit board 112 is reached. At that time, the adhesion layer 116 and the insulating layer of a wiring layer 115 in the signal-processing circuit board 112 are also removed. Moreover, a film of the insulating layer 113 is formed on a side wall of the hole so that the first through electrode 111 and the antenna substrate 104 are not electrically conducted. As the insulating layer 113, the same material as those of the insulating layers 105, 106 can be used. For example, silicon oxide is formed with a thickness of 1 µm. After that, by making a metal film by sputtering film formation or a plating method, the first through electrode 111 is made in the hole. The first through electrode 111 is preferably formed by metal with a large conductivity, and it is formed by plating growth of copper in this embodiment. By performing as above, a driving voltage or current output from the signal-processing circuit board 112 can be applied to the rectifier element 107 through the first through electrode 111 and the first lead line 108. The bonding may also serve as metal-metal bonding in which a metal film is formed on a connection surface or wiring connection by a bump (connection electrode).

In the signal-processing circuit board 112, a transistor layer 114 constituting a pixel circuit or a drive circuit driving the pixel circuit are disposed on a semiconductor board such as silicon, and the wiring layer 115 including a plurality of insulating films and wirings is disposed on the transistor layer 114. The first through electrode 111 is connected to the wiring included in the wiring layer 115.

On the antenna substrate 104, a peripheral electrode 117 is disposed around the loop antenna 101, and the second lead line 109 is connected to the peripheral electrode 117. The peripheral electrode 117 is disposed away from the first lead line 108 or the first through electrode 111 so as not to be electrically connected.

The first lead line 108, the second lead line 109, and the peripheral electrode 117 are formed in the conductive layer common to the loop antenna 101 in order to facilitate manufacture in this embodiment, but they may be formed by a different layer or a different material through the through hole. As a material, metal or an alloy such as Ag, Au, Cu, W, Ni, Cr, Ti, Al, AlCu, AlSi, AuIn, TiN and the like can be used. Moreover, similarly to the loop antenna 101, they are in contact through the insulating layer 105 so that they are not electrically connected to the antenna substrate 104 and are covered by the insulating layer 106 for protection.

(Recess Structure) Between the loop antenna 101 and the peripheral electrode 117, recess structures 118, 119 are provided, and inside the loop antenna 101, the recess structure 120 is provided. The recess structures 118, 119, 120 are dents that a part of the antenna substrate 104 was removed. The recess structures 118, 119 have a ring shape on a plan view. On a lower part or in the vicinity of the first lead line 108 and the second lead line 109, the antenna substrate 104 was not removed and thus, a step is not generated, and a step-cut of the wiring in the first lead line 108 or the second lead line 109 can be prevented.

When an antenna is to be made on the antenna substrate 104, it is known that the terahertz wave propagates into the antenna substrate 104 and causes a loss (lost). Therefore, by forming the recess structures 118, 119, 120, the antenna substrate 104 is partially removed, and by giving a loss to a mode other than a propagation mode in the substrate of the terahertz wave to be detected, reduction of reception power loss can be realized.

The recess structures 118, 119, 120 can be formed by machining the antenna substrate 104 by a photolithography process and an etching process by a Bosch method. Alternatively, manufacture is possible by wet etching using potassium hydroxide (KOH) or tetramethylammonium hydroxide (TMAH) or gas etching using xenon difluoride (XeF₂). Moreover, the manufacture is also possible by using sand blast or laser ablation.

(Rectifier Element) The rectifier element 107 is electrically connected to the loop antenna 101 through the contact hole made in the insulating layer 105 which insulates the loop antenna 101 and the antenna substrate 104 from each other. Moreover, in order to detect the frequency of the terahertz wave, a high-speed switching characteristic such as a Schottky-barrier diode is preferably used for the rectifier element 107. However, not being limited to the Schottky-barrier diode, a rectifier diode such as a diode using p-n junction can be also used for the rectifier element 107.

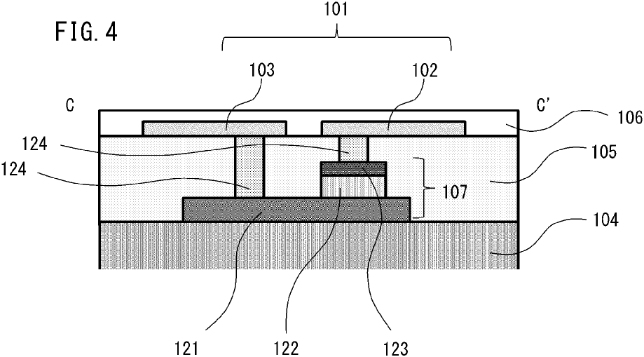

FIG. 4 is a sectional view for explaining a configuration using the Schottky-barrier diode as the rectifier element 107, which is a sectional view on a C-C′ line in FIG. 1. In FIG. 4, the signal-processing circuit board 112 is omitted for simplification.

The rectifier element 107 has a configuration in which a first semiconductor layer 121, a second semiconductor layer 122, which is the same conductive type as the first semiconductor layer 121 and has impurity concentration lower than that of the first semiconductor layer 121, and a metal layer 123 are formed in order on the antenna substrate 104. A surface area of the first semiconductor layer 121 is larger than the surface area of the second semiconductor layer 122. The first semiconductor layer 121 and the metal layer 123 are terminals of the rectifier element 107, and the first semiconductor layer 121 and the metal layer 123 are connected to the loop antenna 101, respectively, through the contact hole made in the insulating layer 105. In this embodiment, the first part 102 of the loop antenna is connected to the metal layer 123, and the second part 103 of the loop antenna is connected to the first semiconductor layer 121. In the contact hole made in the insulating layer 105, a conductive plug 124 is embedded, and the rectifier element 107 and the loop antenna 101 are connected. As the plug 124, tungsten or another material can be used. By forming the loop antenna 101 so as to cover the inside of the contact hole, the rectifier element 107 and the loop antenna 101 may be connected directly.

In making of the Schottky-barrier diode, which is the rectifier element 107, in order to make a Schottky contact on the antenna substrate 104 made of silicon, it is preferable that the impurity concentration of the second semiconductor layer 122 is approximately 1 × 10¹⁸ [pieces/cm³] or less. Moreover, a thickness of the second semiconductor layer 122 is preferably 50 nm to 500 nm. Control methods of the impurity concentration include a method of direct growth of a silicon-crystal thin film having desired impurity concentration by epitaxial growth or direct injection of impurity atoms into silicon by a method of ion implantation or the like. For example, those which are epitaxial grown to approximately 200 nm of n-type silicon having the impurity concentration of 2 × 10¹⁶ [pieces/cm³] are used. Since characteristics of the Schottky-barrier diode are determined by a work function of silicon (second semiconductor layer 122) and metal (metal layer 123), the characteristics are largely changed depending on a type of the material of the metal layer 123 used as an electrode. For example, Co with a thickness of 50 nm can be used for the metal layer 123. In addition, Al, W, Cr, Mo, Ni, V, Pd, Mg, Ti and the like can be used in general. A barrier layer such as TiN may be provided on the metal layer 123.

(Loop Antenna) A length of a circumference of the loop antenna 101, which is a resonator length, can be determined by a resonance frequency of the loop antenna 101 (designed resonance frequency; frequency of the terahertz wave to be received). Specifically, with respect to the wavelength λ (resonance wavelength λ) in the loop antenna 101 of an electric wave of the frequency selected as the resonance frequency, the length of the circumference of the loop antenna 101 is set to approximately (n + 0.5) × λ (n is 0 or a natural number) such as 0.5 λ, 1.5 λ, and 2.5 λ. That is, since the length of the loop antenna 101 is 0.5 times, 1.5 times, or 2.5 times, ... of the resonance wavelength λ of the antenna, the loop antenna 101 can receive the terahertz wave with the frequency corresponding to the resonance wavelength λ.

The resonance wavelength of an object indicates a wavelength when the terahertz wave received by a receiver (loop antenna 101) propagates in the object. Specifically, the resonance wavelength of the loop antenna 101 indicates the wavelength of the terahertz wave with which the loop antenna 101 resonates at the propagation in the loop antenna 101. Therefore, the resonance wavelength in the air, the resonance wavelength in the loop antenna 101, and the resonance wavelength of the antenna substrate 104 are values different from one another. The resonance wavelength of the loop antenna 101 can be indicated by a value obtained by synthesizing relative permittivity of the atmospheric air surrounding the loop antenna 101, the antenna substrate 104, the insulating layer 105 which bonds the loop antenna 101 and the antenna substrate 104 together and the like. In this embodiment, in the case where the loop antenna 101 receives the terahertz wave with the frequency of 1 THz and the wavelength of 300 µm in the air, for example, the resonance wavelength λ of the loop antenna 101 is 150 µm, which is approximately a half of the wavelength of 300 µm in the air.

In this embodiment, the length of the circumference of the loop antenna 101 is adjusted to be 1.5 λ with respect to the wavelength λ (resonance wavelength λ) of the resonance frequency (designed resonance frequency) of the loop antenna 101. That is, a relationship of 2πr = 1.5 λ is established between the radius r and the resonance wavelength λ of the loop antenna 101. When the size of the loop antenna 101 is to be made smaller, the length of the circumference of the loop antenna 101 may be adjusted to be 0.5 λ so that a relationship of 2πr = 0.5 λ is established. On the other hand, if a reception area of the loop antenna 101 is to be increased, adjustment may be made so that the length of the circumference of the loop antenna 101 is (n + 0.5) × λ, and the value of the natural number n is increased. However, since impedance of the loop antenna 101 is also changed by the adjustment of the length of the circumference of the loop antenna 101, impedance matching (impedance matching) with the rectifier element 107 needs to be adjusted.

By considering reduction of resistance loss of the antenna and suppression on production tolerance, a width of the loop antenna 101 is preferably 0.1 µm to 10 µm, and a film thickness of the loop antenna 101 is preferably 0.1 µm to 1 µm.

A film thickness of the insulating layer 105 which bonds the loop antenna 101 and the antenna substrate 104 together is preferably 1.6 µm to 2.6 µm. Within this range, the impedance matching between the loop antenna 101 and the rectifier element 107 and suppression of defective connection of the loop antenna 101 and the rectifier element 107 in the contact hole can be both realized.

(Pillar Width) In the antenna substrate 104 below the loop antenna 101 sandwiched between the recess structure 118 and the recess structure 120 or between the recess structure 119 and the recess structure 120, a pillar width of a loop part in the loop antenna 101 is defined. Specifically, on a plan view of the loop antenna 101, a dimension in a perpendicular direction to a tangent line of the loop part of the loop antenna 101 (dimension L1 indicated by an arrow described in FIGS. 1 and 2) is the pillar width.

As described above, the resonance wavelength λ of the loop antenna 101 depends on the relative permittivity of the air surrounding the loop antenna 101, the antenna substrate 104, the insulating layer 105 which bonds the loop antenna 101 and the antenna substrate 104 together and the like. Thus, the resonance wavelength λ depends on the pillar width L1, which is a dimension of a part of the antenna substrate 104.

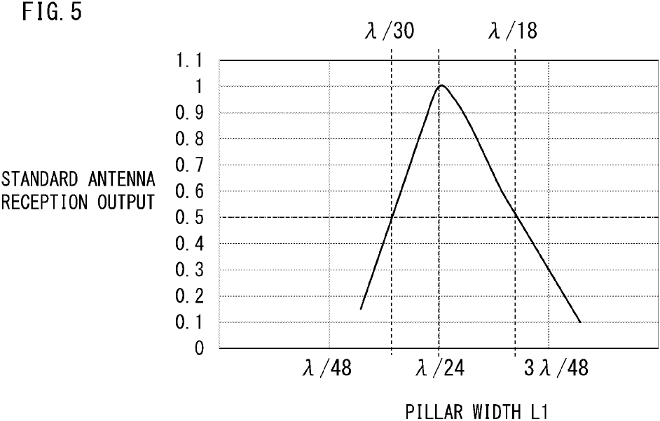

FIG. 5 is a graph illustrating a relationship between the pillar width L1 and a standard antenna reception output (standard value with a peak value of the antenna reception output at 1). According to FIG. 5, the antenna reception output reaches the peak at the pillar width of λ/24. Assuming that a range until the antenna reception output is reduced by half is an effective range, the pillar width is preferably λ/30 to λ/18. When the terahertz wave with the frequency of 0.5 THz and the wavelength of 600 µm in the air, it is preferable that the resonance wavelength λ of the loop antenna 101 is 300 µm, and the pillar width L1 is 10 µm to 17 µm.

(Reflective Layer) As one means for adjusting a radiation pattern of the antenna, a reflective layer 125 is preferably provided on a rear surface of the antenna substrate 104, a front surface of the signal-processing circuit board 112, or between the antenna substrate 104 and the signal-processing circuit board 112. That is, the reflective layer 125 is preferably provided between the loop antenna 101 and the signal-processing circuit board 112. As a material for the reflective layer 125, metal or an alloy is used similarly to the loop antenna 101. In order to obtain an effect such as directivity improvement by the reflective layer 125, by setting a distance between the loop antenna 101 and the reflective layer 125 to approximately 0.5 times of the resonance wavelength of the antenna substrate 104, the radiation pattern can be adjusted without deteriorating reception sensitivity of the terahertz wave.

Moreover, in order to cause the reflective layer 125 to play a role of adjusting the directivity of the loop antenna 101, the reflective layer 125 preferably covers a range larger than that of the loop antenna 101. More preferably, a range of the distance from the loop antenna 101 within 0.25 times of the resonance wavelength is covered. As a result, most of the terahertz wave having propagated in the antenna substrate 104 is reflected by the reflective layer 125 without being affected by scattering or the like and re-radiated into the air and thus, the radiation pattern can be concentrated to the perpendicular direction to the loop antenna 101.

In a state where the reflective layer 125 is electrically connected between the pixels, the terahertz wave propagates in the reflective layer 125 constituted by conductive metal, and the received terahertz wave might leak to the adjacent pixel in some cases. Thus, in order to prevent the crosstalk between the pixels and to prevent mixing-in of a noise, the reflective layer 125 is preferably insulated electrically from the other members and the reflective layers 125 of the other pixels, that is, it is in an electrically floating state. Therefore, an insulating layer 126 is preferably formed between the antenna substrate 104 and the reflective layer 125.

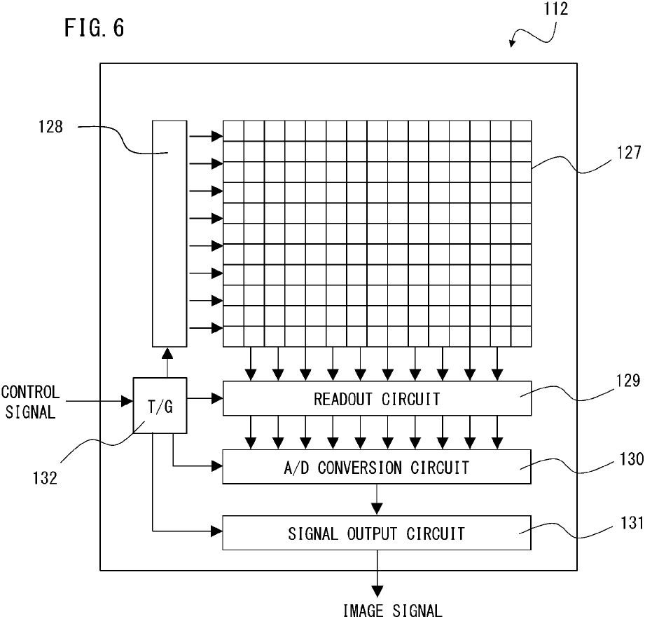

(Signal-Processing Circuit Board) FIG. 6 is an example of a circuit mounted on the signal-processing circuit board 112, which is a signal-processing substrate of the antenna device in this embodiment.

The signal-processing circuit board 112 includes a pixel circuit region 127, a vertical scanning circuit 128, a readout circuit 129, an analog to digital (A/D) conversion circuit 130, a signal output circuit 131, and a timing generator (T/G) 132. On the pixel circuit region 127, a large number of the pixel circuits are arrayed two-dimensionally. Each of the pixel circuits is connected to each of the loop antennas 101 in an antenna array of the antenna substrate 104 and performs accumulation and amplification of signals from the antenna. In the vertical scanning circuit 128, a control signal is output so that the pixel circuit in the pixel circuit region 127 is sequentially selected for each row. In the readout circuit 129, a column amplifier, a correlated double sampling (CDS) circuit, an adding circuit and the like are provided, for example, and amplification, addition and the like are performed to the pixel signal read out of the pixel circuit of the row selected by the vertical scanning circuit 128 through a vertical signal line (not shown). The A/D conversion circuit 130 converts an analog signal based on the pixel signal output from the readout circuit 129 to a digital signal. The signal output circuit 131 transmits the digital signal output from the A/D conversion circuit 130 as an image signal to an external device in a format determined in advance. The timing generator (T/G) 132 transmits a timing signal to the vertical scanning circuit 128, the readout circuit 129, the A/D conversion circuit 130, and the signal output circuit 131 and controls an operation of each circuit. Moreover, by receiving a control signal from external equipment, it switches an operation mode or changes a pulse width or an output timing of the timing signal.

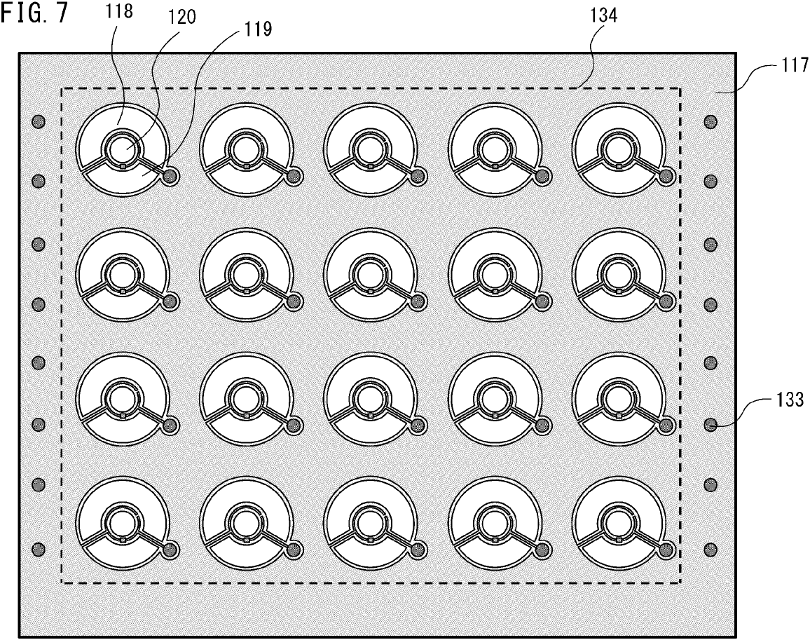

(Antenna Array Arrangement) FIG. 7 is an example of a plan view illustrating an arrangement of the antenna array of the antenna device in this embodiment. FIG. 7 illustrates an example of the antenna array of the pixels explained by using FIGS. 1 to 4 in 4 rows × 5 columns disposed in plural on the antenna substrate 104.

According to FIG. 7, the peripheral electrode 117 is disposed between the loop antennas in each pixel, and the second lead line 109 of each pixel is connected in common by the peripheral electrode 117. A fixed voltage is preferably applied to the peripheral electrode 117. As the fixed voltage, it may be 0V (ground potential) or only needs to be a certain voltage other than 0V.

On the signal-processing circuit board 112 which is stacked with the antenna substrate 104, the pixel circuit is disposed correspondingly to the pixel, and the first lead line 108 of each pixel is connected to the pixel circuit through the first through electrode 111. Thus, the signal from the antenna of each pixel is individually read out independently through the first lead line 108 and the first through electrode 111, respectively.

The peripheral electrode 117 is disposed on an antenna array region 134 (region indicated by a broken line). A dimension in the row direction of the antenna array region 134 is defined as row-number times of a pixel pitch, and a dimension in the column direction as column-number times of the pixel pitch. The pixel pitch is preferably a wavelength or less of the received terahertz wave in the air and more preferably a half or less of the wavelength of the received terahertz wave in the air. The antenna array region 134 exemplified in FIG. 7 shows an example of a dimension of four times of the pixel pitch for the row direction and a dimension of five times of the pixel pitch in the column direction.

It is preferable that 50% or more of a region excluding the regions of the recess structures 118, 119, 120 in the antenna array region 134 is covered by the peripheral electrode 117. That is because, since the antenna substrate 104 is covered by the conductive layer, a reception power loss by the propagation of the terahertz wave in the antenna substrate 104 can be reduced, and disturbance in the radiation direction of the terahertz wave can be suppressed. Moreover, the impedance is lowered by enlargement of the area of the peripheral electrode 117, potential fluctuation of the peripheral electrode 117 is suppressed, and the crosstalk between the pixels can be reduced.

However, the regions for the loop antenna 101, the first lead line 108, and the second lead line 109 and a space with the recess structures 118, 119, 120 for stable production thereof need to be ensured. Thus, it is more preferable that 75% or less of the region excluding the regions for the recess structures 118, 119, 120 in the antenna array region 134 is covered by the peripheral electrode 117.

In an outer peripheral part of the antenna array region 134, a space for disposing the through electrode on the peripheral electrode 117 can be ensured easily and thus, a plurality of second through electrodes 133 can be disposed. The second through electrode 133 may be disposed on all the four sides of the peripheral electrode 117, may be disposed on opposing two sides, or may be disposed only on one side. By connecting the second through electrode 133 to a wiring of the signal-processing circuit board 112, the impedance of the peripheral electrode 117 is lowered, and the potential fluctuation can be further reduced. The second through electrode 133 can be produced in the same process as that of the first through electrode 111.

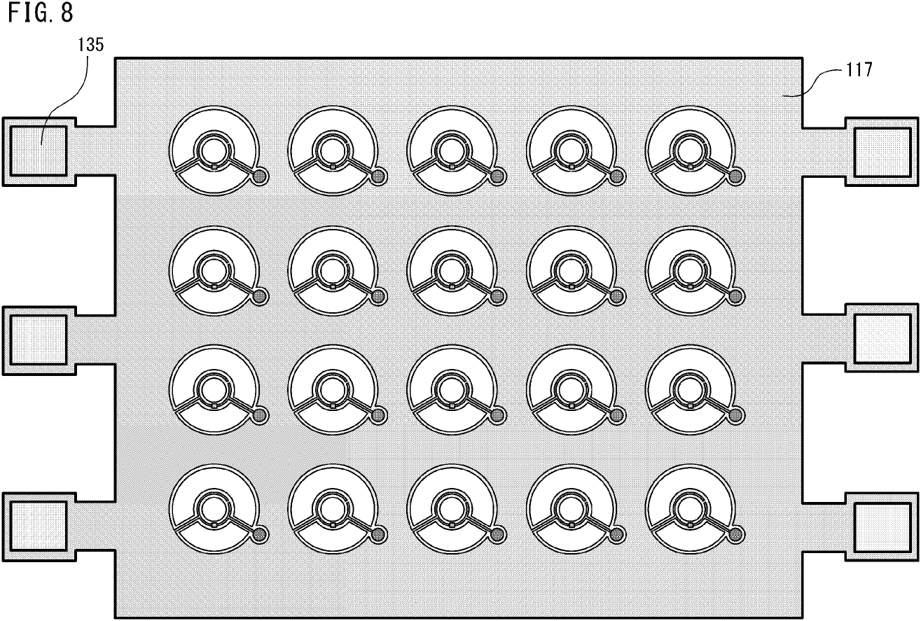

FIG. 8 is another example of a plan view illustrating the arrangement of the antenna array of the antenna device in this embodiment. A point different from the configuration in FIG. 7 is that it has a pad terminal 135 connected to the peripheral electrode 117 connected in common to each of the pixels. The pad terminal 135 is formed in the conductive layer common to the peripheral electrode 117, and a surface of the conductive layer is opened. Thus, an external power-supply circuit, control circuit or the like can be connected by using a wire bonding, an anisotropic conductive film or the like. The pad terminal 135 and the peripheral electrode 117 may be connected through a different conductive layer via the through hole.

As described above, according to the configuration of this embodiment, the through electrode is disposed only for the first lead line 108, and the second lead line 109 is connected in common in all the pixels. Moreover, since the through electrode is not disposed for the second lead line 109, the number of the through electrodes can be reduced for that portion, and a possibility of defective bonding can be reduced.

Moreover, since the pixel circuit is disposed correspondingly to the loop antenna 101 of each pixel in the signal-processing circuit board 112, a wiring region for connecting the through electrode needs to be ensured. Thus, the decrease of the number of the through electrodes required for one pixel improves a degree of freedom in layout of the pixel circuit and contributes to improvement of the resolution of the pixel.

Furthermore, while the number of the through electrodes is decreased, the impedance of the peripheral electrode can be lowered, and the potential fluctuation of the peripheral electrode 117 can be reduced. As a result, the operation of the antenna device is made stable, the crosstalk between the pixels is suppressed, and the image quality can be improved.

### Second Embodiment

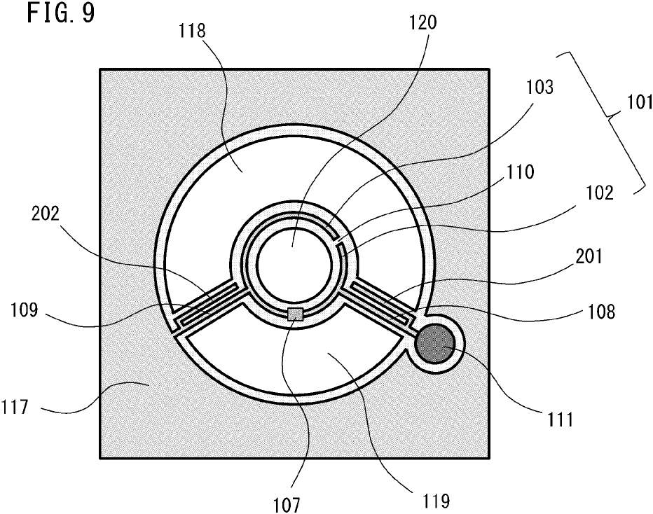

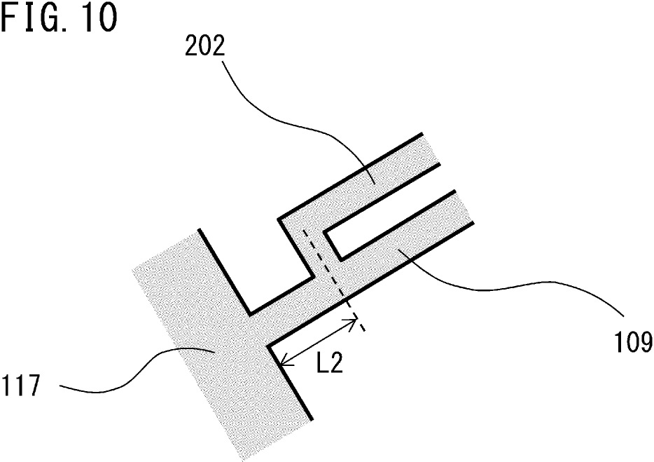

An antenna device in a second embodiment of this disclosure will be explained by using FIGS. 9 and 10. The antenna device according to the second embodiment is different from the antenna device according to the first embodiment in a point that the first lead line 108 and the second lead line 109 have a distribution constant filter. As the distributed constant filter, a stub is used. In this embodiment, explanation will be omitted for the configuration similar to that of the first embodiment.

The antenna device in this embodiment includes a first stub 201 connected to the first lead line 108 and a second stub 202 connected to the second lead line 109. The first stub 201 and the second stub 202 are metal wirings formed in the conductive layer common to the loop antenna 101, the first lead line 108, the second lead line 109, or the peripheral electrode 117. Moreover, they are in contact with the antenna substrate 104 through the insulating layer 105 so as not to be electrically connected and are covered by the insulating layer 106 for protection.

Since this stub adjusts a position or a shape for connection, the distributed constant filter can be given to the first lead line 108 and the second lead line 109. For example, by providing the stub with a length of approximately λ/4 at a position of approximately λ/4 from a node of an electromagnetic field (connection part of the first lead line 108 or the second lead line 109) with respect to the resonance wavelength λ, a notch filter to the wavelength λ can be formed. FIG. 9 illustrates an example of a stub in which the first stub 201 and the second stub 202 are L-shaped, but a stub of various shapes such as a rectangle, a fan shape or the like can be applied. By providing the distributed constant filter as above, the pixel configured by the rectifier element 107, the loop antenna 101, the recess structures 118, 119, 120 can be easily separated from the signal-processing circuit board 112, which is a connection destination of the first lead line 108. Alternatively, the pixel configured by the rectifier element 107, the loop antenna 101, the recess structures 118, 119, 120 can be easily separated from the peripheral electrode 117, which is a connection destination of the second lead line 109. As a result, in the antenna device, the impedance matching state can be maintained easily.

As shown in FIG. 9, the L-shaped first stub 201 and the first lead line 108 or the L-shaped second stub 202 and the second lead line 109 are opposed to each other. According to the configuration as above, directions of the currents distributed in the first stub 201 and the first lead line 108 or in the second stub 202 and the second lead line 109 become opposite to each other. As a result, the electromagnetic field leaking from the first lead line 108, the second lead line 109, the first stub 201, and the second stub 202 to the outside is suppressed, and side lobe in the directivity of the antenna or spread of the directivity can be suppressed.

Subsequently, a positional relationship between a connection part in the second stub 202 in the second lead line 109 and the peripheral electrode 117 will be explained.

At the connection part of the second stub 202, the electric field at the resonance wavelength λ is the minimum, and the impedance becomes substantially zero. Thus, by connecting the second lead line 109 and the peripheral electrode 117 as close as possible to the connection part of the second stub 202, current distribution can be suppressed, and the potential of the peripheral electrode 117 is made stable.

FIG. 10 is an enlarged view of the connection part of the second stub 202 in the second lead line 109. A distance from a center in a line width of the second stub 202 in the connection part to an end part of the peripheral electrode 117 is assumed to be L2.

In this embodiment, the distance L2 is preferably ⅒ or less of the resonance wavelength. More preferably, the distance L2 is set to 1/20 or less of the resonance wavelength λ. That is because, in the case of the size of 1/20 to ⅒ or less of the resonance wavelength λ in general in the electromagnetic field theory, effects of reflection, refraction, scattering are extremely small with respect to the wavelength λ, and it can be regarded as being in contact. Moreover, in a computer simulation of the finite element method or the like, too, the aforementioned size is regarded as an index for a mesh size.

When the terahertz wave with the frequency of 0.5 THz and the wavelength of 600 µm in the air is received, it is preferable that the resonance wavelength λ of the loop antenna 101 is 300 µm, and the distance L2 is 30 µm or less, or more preferably it is 15 µm or less.

As described above, according to the configuration of this embodiment, the second stub 202 connected to the second lead line 109 is provided, and the second lead line 109 and the peripheral electrode 117 are connected as close as possible to the connection part. At the connection part of the second stub 202, the electric field is the minimum at the resonance wavelength λ, and the current distribution can be suppressed by connecting the second lead line 109 and the peripheral electrode 117 as close as possible to the connection part, and the potential fluctuation of the peripheral electrode 117 can be reduced. As a result, the operation of the antenna device is made stable, the crosstalk between the pixels is suppressed, and the image quality can be improved.

### Third Embodiment

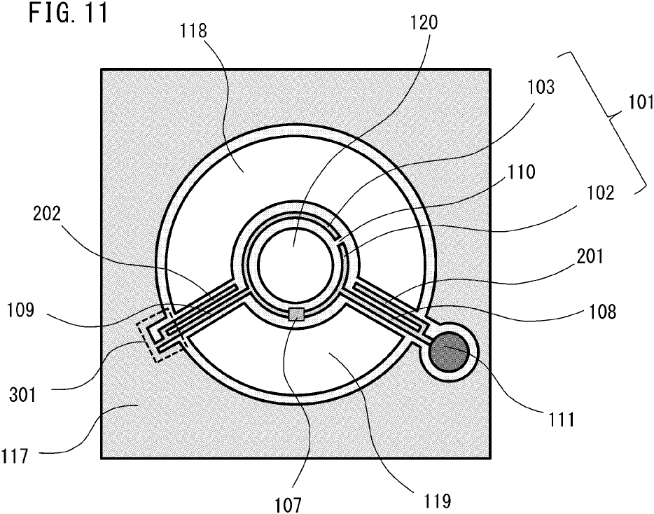

An antenna device in a third embodiment of this disclosure will be explained by using FIG. 11. The antenna device according to the third embodiment is different from the antenna device according to the second embodiment in a shape of the part where the second lead line 109 is connected to the peripheral electrode 117. In this embodiment, explanation will be omitted for the configuration similar to that of the first embodiment or the second embodiment.

In the third embodiment, in the part where the second lead line 109 is connected to the peripheral electrode 117, the peripheral electrode 117 has a notch 301. The second lead line 109 is connected to the peripheral electrode 117 inside the notch 301.

As described above, since the second stub 202 is provided at the position of λ/4 from the node of the electromagnetic field (connection part between the loop antenna 101 and the second lead line 109) with respect to the resonance wavelength λ, the second lead line 109 needs the length for that portion. Thus, by connecting the second lead line 109 in the notch 301, an area for the peripheral electrode 117 can be ensured wide, while the required length is ensured for the second lead line 109.

In this embodiment, the configuration including the second stub 202 was explained, but the configuration of the aforementioned notch 301 can be also applied to the configuration not including the second stub 202 as the first embodiment.

As described above, according to the configuration of this embodiment, since the second lead line 109 is connected to the peripheral electrode 117 inside the notch 301 formed in the peripheral electrode 117, the area for the peripheral electrode 117 can be ensured wide, while the required length is ensured for the second lead line 109. Therefore, the impedance of the peripheral electrode 117 can be lowered, and the potential fluctuation of the peripheral electrode 117 can be reduced. As a result, the operation of the antenna device is made stable, the crosstalk between the pixels is suppressed, and the image quality can be improved.

### Fourth Embodiment

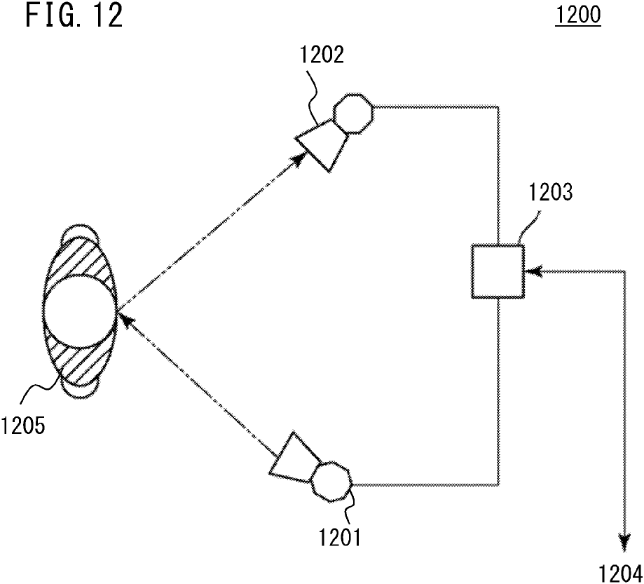

A detection system in a fourth embodiment of this disclosure will be explained by using FIG. 12. The detection system may be a system capable of capturing images, for example a camera system. In the present embodiment, a camera system will be described as an example. FIG. 12 is a schematic diagram for explaining the configuration of a camera system 1200 using terahertz waves.

The camera system 1200 has an oscillation device 1201, a detection device 1202 and a processing unit 1203. The oscillation device 1201 can transmit electromagnetic waves such as terahertz waves, and the oscillation device 1201 can be an antenna device using a semiconductor element such as an RTD (Resonant Tunneling Diode). Antenna devices as described in the above embodiments can be applied to the detection device 1202. The terahertz wave transmitted from the oscillation device 1201 is reflected by an object 1205 and detected by the detection device 1202. The processing unit 1203 processes the signal detected by the detection device 1202. Image data generated by the processing unit 1203 are output from an output unit 1204. With such a configuration, the camera system 1200 can acquire terahertz images.

The oscillation device 1201 or the detection device 1202 may be provided with an optical section. The optical section includes at least one material transparent to terahertz waves, such as polyethylene, Teflon (registered trademark), high-resistance silicon, and a polyolefin resin, and may be composed of multiple layers.

The camera system described in the present embodiment is merely an example, and may be in other forms. In particular, the information acquired by the system is not limited to image information, and the detection system may detect signals.

(Other Embodiments) Each of the embodiments is only an example of materialization in working of the present disclosure, and a technical range of the present disclosure should not be interpreted in a limited manner by them. That is, the present disclosure can be worked in various forms without departing from a technical idea thereof or major features thereof.

For example, the embodiments described above may have a configuration in which at least one recess structure among the recess structures 118, 119 between the loop antenna 101 and the peripheral electrode 117 and the recess structure 120 inside the loop antenna 101 is provided. Even in this case, the antenna substrate 104 is partially removed, and by giving a loss to the mode other than the in-substrate propagation mode of the terahertz wave to be detected, reduction of the reception power-loss can be realized.

According to this disclosure, the antenna device in which the crosstalk between the antennas is suppressed while a pixel defect is suppressed, and the image quality and yield are improved can be provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2022-071139, filed on Apr. 22, 2022, which is hereby incorporated by reference herein in its entirety.

What is claimed is:

1. An antenna device comprising:
an antenna array constituted by a plurality of antennas disposed on a support substrate;
a signal-processing substrate configured to be stacked with the support substrate;
a plurality of rectifier elements disposed correspondingly to each of the plurality of antennas; and
a peripheral electrode disposed between the plurality of antennas on the support substrate, wherein
the antenna comprises:
a first part electrically connected to one of terminals of the rectifier element;
a second part electrically connected to the other terminal of the rectifier element;
a first lead line connected to the first part;
a second lead line connected to the second part; and
a first through electrode connected to the first lead line and the signal-processing substrate; and
the second lead line of the antenna is connected to the peripheral electrode.

2. The antenna device according to claim 1, wherein
a recess structure is formed in at least either one of a space between the antenna and the peripheral electrode and an inside of the antenna.

3. The antenna device according to claim 2, wherein
the recess structure is formed between the antenna and the peripheral electrode and inside the antenna; and
on a plan view of the antenna, a dimension in a perpendicular direction with respect to a tangent line of a loop part of the antenna in the support substrate below the antenna sandwiched by the recess structures is 1/30 to 1/18 of a resonance wavelength of the antenna.

4. The antenna device according to claim 2, wherein
the recess structure is formed between the antenna and the peripheral electrode and inside the antenna; and
on a plan view of the antenna, a dimension in a perpendicular direction with respect to a tangent line of a loop part of the antenna in the support substrate below the antenna sandwiched by the recess structures is 10 µm to 17 µm.

5. The antenna device according to claim 2, wherein
on a plan view of the support substrate, 50% or more of a region excluding a region occupied by the recess structure in a region occupied by the antenna array is covered by the peripheral electrode.

6. The antenna device according to claim 2, wherein
on a plan view of the support substrate, 75% or less of a region excluding a region occupied by the recess structure in a region occupied by the antenna array is covered by the peripheral electrode.

7. The antenna device according to claim 1, further comprising:
a second through electrode that electrically connects the peripheral electrode and the signal-processing substrate on an outer peripheral part of the antenna array.

8. The antenna device according to claim 1, wherein
the first lead line, the second lead line, and the peripheral electrode are formed in a conductive layer common to the antenna.

9. The antenna device according to claim 1, wherein
the second lead line has a stub.

10. The antenna device according to claim 9, wherein
the stub is formed in a conductive layer common to the antenna array.

11. The antenna device according to claim 9, wherein
at a position of ⅒ or less of a resonance wavelength in the antenna array from a connection position between the second lead line and the stub, the second lead line and the peripheral electrode are connected.

12. The antenna device according to claim 9, wherein
at a position of 30 µm or less from a connection position between the second lead line and the stub, the second lead line and the peripheral electrode are connected.

13. The antenna device according to claim 9, wherein
the stub has a part extending so as to oppose the second lead line.

14. The antenna device according to claim 1, wherein
a notch is formed in the peripheral electrode; and
the second lead line is connected to the peripheral electrode inside the notch.

15. The antenna device according to claim 1, wherein
the rectifier element is a Schottky-barrier diode.

16. The antenna device according to claim 1, wherein
between the support substrate and the signal-processing substrate, a reflective layer formed of metal or an alloy is provided.

17. The antenna device according to claim 1, wherein
a fixed voltage is applied to the peripheral electrode.

18. The antenna device according to claim 1, wherein
the antenna device detects a terahertz wave with a frequency of at least 0.03 THz and not more than 30 THz.

19. The antenna device according to claim 1, wherein
the antenna is a loop antenna.

20. A detection system comprising:
the antenna device according to claim 1;
a transmitting device for transmitting an electromagnetic wave; and
a processing portion which processes a signal from the antenna device.
